(19) United States
(12) Patent Application Publication
(10) Pub. No.: US 2024/0266133 A1
(43) Pub. Date: Aug. 8, 2024

(54) SWITCHING DEVICE AND METHOD FOR OPERATING A SWITCHING DEVICE

(71) Applicant: E.G.O. Elektro-Gerätebau GmbH, Oberderdingen (DE)

(72) Inventor: Robin Abendschoen, Eppingen (DE)

(21) Appl. No.: 18/406,380

(22) Filed: Jan. 8, 2024

(30) Foreign Application Priority Data
Feb. 2, 2023 (DE) 10 2023 200 840.8

(51) Int. Cl. H01H 89/04; H01H 37/04; H01H 37/26; H05B 6/12; H01H 37/52

(52) U.S. Cl. CPC H01H 89/04; H01H 37/04; H01H 37/26; H05B 6/1209; H01H 37/52

(57) ABSTRACT

A switching device for an electrical appliance has a housing and an adjustably designed switch therein that operates cyclically. An adjusting device for setting a different cycle behavior of the switch is provided that acts mechanically on the switch. It has a rotary shaft with a varying contour device that has along the circumferential direction a varying contour. An electrothermic tripping device is provided for the switch and has a heating element and two electrical connections thereto. At least one connection has two disconnectable connecting contacts in the current path of the connection. The switching device has a disconnector which acts mechanically on one of the connections of the tripping device in order to disconnect its two connecting contacts. The disconnector can be moved in a disconnecting rotary angle range of the rotary shaft by the contour device, in order to disconnect the connecting contacts in the disconnecting rotary angle range, and otherwise not.

### CROSS-REFERENCE TO RELATED APPLICATIONS

This application claims priority to German Application No. 10 2023 200 840.8, filed Feb. 2, 2023, the contents of which are hereby incorporated herein in its entirety by reference.

### FIELD OF APPLICATION AND PRIOR ART

The invention relates to a switching device for an electrical appliance or an electrical domestic appliance, in particular designed as a cyclic power control unit, and to a method for operating a corresponding switching device.

It is for example known from U.S. Pat. No. 6,211,582 B1 how to design a switching device for a hob as a cyclically operating power control unit. A switch is provided here with a switching spring, at whose end a switch contact is arranged. A bimetal tripping device, on which a heating element is provided for heating, acts on the switch, with the result that the bimetal tripping device deflects or bends, and so trips, in particular opens, the switch. Furthermore, an adjusting device in the form of a contour device with a contour washer of varying radius is provided, using which a power stage can be set at the power control unit for a heating device of the hob. The power stages of the power control unit range here from 0% to 100%, wherein in particular a substantially arbitrary intermediate power stage between zero power and full power may be set. Due to the heating and to the bimetal tripping device, the power control unit with the switch operates in a cyclical manner. At the power stage 100%, heating is permanently active as a rule. This requires energy, which remains unused for functional purposes and can also cause thermal problems.

### PROBLEM AND SOLUTION

The object of the present invention is to provide a switching device as stated above and a method for the operation thereof, using which prior art problems can be avoided and which make it in particular possible to effect a permanent operation at full power or to set the power stage permanently at 100%, preferably without consuming energy or causing thermal problems.

This object is solved by a switching device having the features of claim 1 and by a method having the features of claim 23. Advantageous and preferred embodiments of the invention are the subject matter of further claims and are explained in greater detail below. Some of the features are described only for the switching device or only for the method. They should however be applicable, by themselves and independently of one another, for both the switching device and a corresponding method to operate it. The wording of the claims is incorporated by express reference into the content of the description.

In accordance with the invention, it is provided that the switching device has a housing, advantageously a plastic housing. This may be in several parts, advantageously having a lower part and an upper part. The switching device may have in the housing at least one switch which is designed adjustable, in its position inside the housing and/or in its shape, for setting different cycle times for a cyclic operation of the switch. Further switches may be provided as simple disconnecting switches without cycling or the like. The switching device has an adjusting device for setting different cycle times or a different cycle behavior of the switch, wherein the adjusting device acts mechanically on the cyclic switch. The adjusting device has for that purpose a rotary shaft with a varying contour device arranged thereon, or a contour washer arranged on the rotary shaft. It has along the circumferential direction a varying contour, and preferably has a varying radius. Such adjusting devices with contour devices or with a contour washer are known from the prior art, in particular also from similar switching devices, which are also known as energy controllers.

An electrothermic tripping device is also provided in the housing for the switch, wherein this tripping device has a heating element and two electrical connections to the heating element. It also advantageously has a bimetal arm which is heated by the heating element and can deform, so tripping or actuating the switch, i.e. altering its state. At least one connection on the heating element has two disconnectable connecting contacts in the current path of the connection. This allows the current supply to the heating element to be interrupted.

In accordance with the invention, the switching device has a disconnector which is designed to act mechanically on at least one of the connections of the tripping device with the two connecting contacts in order to disconnect the latter from one another, whereby the heating element is safely switched off or deactivated. The disconnector is designed such that it may be moved directly or indirectly in at least one disconnecting rotary angle range of the rotary shaft by the contour device, in order to disconnect the connecting contacts by this movement. Otherwise, the connecting contacts may advantageously be designed such that they are not disconnectable. It may be provided here that the connecting contacts can only be disconnected when the disconnector is in the disconnecting rotary angle range, and otherwise not.

The design of the connection on the heating element with the connections plus connecting contacts, which can be disconnected by means of the disconnector, allows the heating element to be switched off or deactivated in a certain disconnecting rotary angle range of the rotary shaft. It is thus for example possible, whenever the switching device or switch is to be permanently closed/switched on, for which the contour device is advantageously used, that the tripping device and above all the heating element are switched off. They are then no longer needed to keep the switch switched on. Unnecessary energy consumption at the heating element can thus be avoided, and in addition an unnecessary and above all potentially harmful overheating of the switching device due to permanent operation of the heating element can be prevented. Even if the heating element is designed such that it has a relatively low continuous output of less than 20 W or even less than 10 W, a heat buildup can occur due to the arrangement of the switching device inside the housing, which is largely closed. This can damage the housing, meaning that it must consist of high-grade and heat-resistant plastics. The invention allows the housing to be designed simpler and less expensive thanks to the reduced risk of damage from overheating. A continuous maximum temperature can then be reduced by at least 10° C. or even 20° C.

In an embodiment of the invention, the one connecting contact may be arranged on the housing in a fixed position, preferably at the connection to the tripping device with the two connecting contacts. It may in particular be designed in the form of a fixed metal connecting bridge. The other connecting contact is then advantageously a contact spring arm, flexibly pressing against it, of a metal contact spring, wherein the entire contact spring plus contact spring arms advantageously consists of metal. Another contact spring arm of this contact spring reaches the tripping device in electrically contacting manner, or is in contact therewith or with its heating element. This may also be done in flexible manner, but this is immaterial for the invention.

The contact spring is mounted in an area between the two ends of the contact spring arms, in particular mounted on the housing, for example on a mounting projection, such that it is still movable or rotatable to a certain degree, at least at one contact arm having the disconnectable connecting contacts. The mounting of the contact spring may be preferably in an area which is arranged closer to the tripping device than to the disconnector.

In an embodiment of the invention, the contact spring may consist of metal, to be electrically conductive for good contacting, and preferably also for good spring properties. It may consist of metal wire, in particular of round metal wire, alternatively of strip-like material, for example a flat strip.

In an embodiment of the invention, the contact spring may have, between the contact spring arms or the ends of the contact spring arms, a holding area extending over a mounting projection on the housing. The mounting projection may be molded onto the housing, preferably by injection molding on an underside of the housing. This mounting projection may be such that the contact spring or the two contact spring arms may be rotated about it in such a way that at least one contact spring arm, advantageously both contact spring arms, can rotate in a kind of pivoting movement about this mounting projection. Advantageously, the contact spring may be wound helically around the mounting projection, in particular when it consists of the aforementioned round metal wire.

In a further embodiment of the invention, there may be a movable transmission member between the contour device on the rotary shaft and the connection or connecting contact, which is in particular the aforementioned contact spring. This transmission member is advantageously arranged/mounted and designed such that a movement of the rotary shaft with the contour device arranged thereon is transmitted to the connection or to the contact spring, in order to move the contact spring plus the connection and thus to disconnect the connection or the connecting contacts and to switch off the heating element.

Such a transmission member can generally be a separate part, i.e. be provided additionally to the contact spring, for example also made from another material, and be simply in contact therewith after fitting of the switching device or be fastened permanently or undetachably thereto, for example by clamping or injection molding. Alternatively, the transmission member may be provided on the contact spring by the design of the latter or be formed for example by bending or shaping of the contact spring.

In an embodiment of the invention, the transmission member may be a lever mounted for rotatable movement, such that a rotary movement disconnects the connecting contacts. The lever may be in contact by a first lever end with the connection or with the contact spring, i.e. be in contact depending on the rotary position. It does not necessarily have to be in permanent contact with the contact spring, but in any event whenever it disconnects the connecting contacts. A pivot mounting of the lever may be between the two lever ends, wherein the precise arrangement of a mounting point influences the ratio of the rotary movement.

It may on the one hand be provided that the other, second lever end is in direct contact with the contour device, which is preferably arranged on the rotary shaft, such that a movement of the second lever end tripped by the rotary shaft depending on the rotary position moves/rotates the lever and thus disconnects the connecting contacts. A forced direct disconnection of the connecting contacts is then assured by direct tripping of the lever.

On the other hand, it may be provided that the other, second lever end is in contact with a slider, wherein this slider in turn is or may be in contact with the contour device such that a movement of the slider tripped by the contour device depending on the rotary position is transmitted to the lever in order to move/rotate it and to disconnect the connecting contacts. This is an indirect tripping of the lever or a forced indirect disconnection of the connecting contacts, which may nevertheless take place with sufficient safety.

In an alternative embodiment of the invention, the transmission member may be a pusher, which can be designed in particular slidable in the linear direction, alternatively in a certain arc. A first end of the pusher may be in direct contact with the contour device of the rotary shaft or with an aforementioned slider, in effect as an indirect solution. The other, second end of the pusher may be in contact with the connection or the connecting contact of the tripping device, in particular also with the contact spring or one of its contact spring arms.

In an advantageous embodiment of the invention, the transmission member may above all if it is a part separate from the contact spring, i.e. provided additionally to the contact spring, consist of plastic, preferably exclusively of plastic.

In a further embodiment of the invention, the contact spring may extend or be arranged in a different plane, extending vertically to the rotary shaft, than the contour device or contour washer for the disconnector. Additionally or alternatively, the contact spring may extend in a different plane than the transmission member, at least than a major part of the transmission member. In this way, an optimum arrangement in the housing may be found in each case.

In another embodiment of the invention, a contact spring may be provided in the switching device for the one connection contact, said spring being shaped such that a protruding section fastened thereto or formed therefrom is in contact with the contour device of the rotary shaft. It is advantageously formed on a contact spring arm which is not in contact with the heating element. This protruding section may replace the aforementioned transmission member or perform a corresponding function. The protruding section may be either additionally attached to the contact spring or integrally formed thereon.

Such a protruding section may for example be bent outwards from a wire of the contact spring or of a contact spring arm, advantageously as a U-shaped section, such that the contact spring arm extends on both sides of the protruding section. This wire may form at least one contact spring arm of the contact spring, and in particular form the entire contact spring, such that in this case the protruding section too is made by bending of the wire relative to the contact spring.

In an embodiment of the invention, the rotary angle range in which the disconnector disconnects the connecting contacts may be 1° to 45° or even 1° to 60°, or at a rotary angle between 260° and 360°, in particular when no end stop is provided, or between 270° and around 308° when such an end stop is provided. Alternatively, it may be between 300° and 360°. Preferably, the rotary angle range may be 5° to 20°. Alternatively or additionally, the rotary angle or rotary angle range may be arranged wherever the cycle times of the switch are such that the switch is permanently closed/switched on. This is a rotary angle range in which the switching device effects permanent operation of an electrical consumer operated therewith. This rotary angle range may be at an end of a possible rotary movement, for example at the high end of a power setting for the consumer. This is usually at the end of a rotation range.

In an embodiment of the invention, the contour device may have not only one, but at least two contour washers, which are arranged one above the other in the direction along the rotary shaft and on the rotary shaft, or are molded thereon, preferably by plastic injection molding. A first contour washer may be advantageously provided for the switch or for its adjustment in a cyclic operation, and another, second contour washer for the disconnector, in particular for an all-pole disconnector, i.e. for its actuation or activation in order to switch the heating element.

With the method in accordance with the invention for operating an electrical appliance with a previously described switching device, an electrical connection to the heating element is therefore disconnected for permanent closing of the switch with a certain setting of the rotary shaft plus contour device in a disconnecting rotary angle range. The heating element is thus deactivated when the switch is closed, i.e. it does not consume any energy and does not generate any disruptive or harmful heat. At the same time, the switch is closed for continuous operation of the electrical appliance or of an electrical function unit thereof, for example of a heating device.

These and further features are found in the description and in the drawings as well as in the claims, where the individual features can each be realized singly or severally in the form of sub-combinations in one embodiment of the invention, and in other fields, and can represent designs advantageous and protectable per se, for which protection is claimed here. The subdivision of the application into individual sections and subheadings does not limit the general validity of the statements made thereunder.

### BRIEF DESCRIPTION OF THE DRAWINGS

Further advantages and aspects of the invention can be found in the claims and in the description of exemplary embodiments of the invention that are explained in the following on the basis of the figures. The drawing shows in:

FIG. 1 a plan view onto a switching device in accordance with the invention, having a switch plus adjusting device therefor, an electrothermic tripping device and a disconnector in the form of a lever,

FIG. 2 the switching device from FIG. 1 in the permanently switched-on state, wherein the lever has interrupted the connection of the tripping device,

FIG. 3 a variation of the switching device from FIG. 1, wherein the disconnector has a linear pusher which is tripped by a separate contour washer, and

FIG. 4 a variation of the switching device from FIG. 3, wherein the separate linear pusher is replaced by a protruding section formed on the contact spring for the tripping device.

### DETAILED DESCRIPTION OF THE EXAMPLES

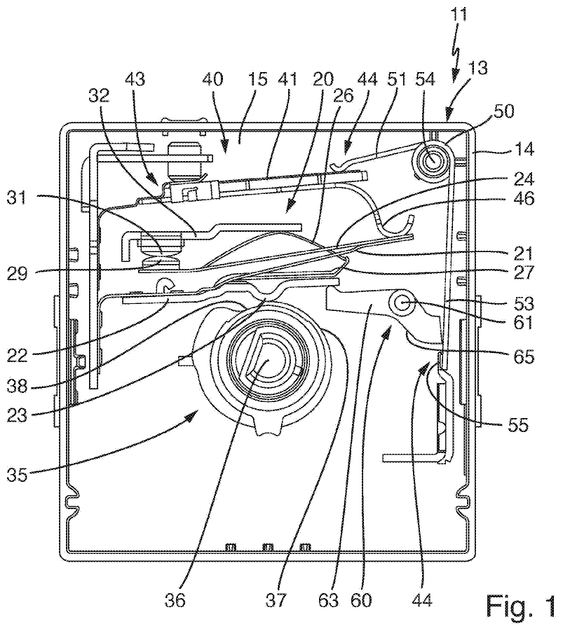

FIG. 1 shows a switching device 11 in accordance with the invention with a housing 13 and a housing lower part 14. A housing upper part has been omitted to permit a better representation of the inner layout of the switching device 11. The housing lower part 14 has a bottom 15 and is made in one piece with the latter, preferably by plastic injection molding. Due to the aforementioned advantages of the invention, with limitation of a maximum temperature in the switching device or its housing 13, in particular due to a heating device to be described in detail in the following, plastics with low temperature resistance may be used. This may for example be PPS, which has a melting point of around 280° C. For lower temperatures, plastics such as PET with a melting point of around 250° C., PPS with a somewhat lower melting point, or Bakelite with an even lower temperature of around 150° C., above which the material disintegrates, may be used. Since PET is considerably less expensive than PPS, significant cost savings can thus be achieved. In particular, much larger quantities of plastic must be used for the housing lower part 14 and for the bottom 15, or for the entire housing 13.

The switching device 11 is largely designed as known from the prior art. It has a switch 20, described at the outset, which is designed as a so-called quick-break switch. The switch 20 has a switch base 21 of thin springy metal, in particular sheet copper, which is fastened to a sturdy slider 22, preferably riveted on or welded on in its left-hand area. The slider 22 consists of thick metal and is connected at its left-hand end via the extended switch base 21 to a metal connecting bridge, with mechanical mounting and electrical contact. In the right-hand area, the slider 22 has a downward-projecting or outward-bent slider projection 23.

The switch 20 has a switching spring arm 24 which is fastened, for example welded or riveted, onto the right-hand free end of the switch base 21. By means of a tensioned arc 26 bent outwards from the left-hand area of the switching spring arm 24, the switch 20 is tensioned for the snap function, in that the right-hand free end of the tensioned arc 26 is on contact with or supported on a hook-like support 27 is and thus tensioned. At the left-hand free end, the switching spring arm 24 has a switch contact 29. This is, in the state shown here, in contact with a counter-contact 31 which is fastened to a contact carrier 32. This is the substantially closed contact of the switch 20. Via this, heating devices, for example of an electrical appliance in which the switching device 11 is installed, are supplied with power. In particular, these may be heating devices of an electric hob which are cyclically operated, such that the switching device 11 operates in a known manner as a so-called energy controller. In this regard, reference is made to the prior art stated at the outset.

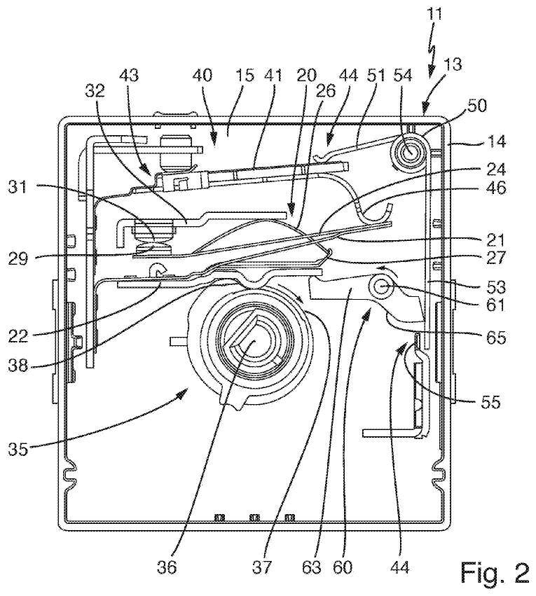

An adjusting device 35 is provided to achieve a different behavior for the cycles of the switching device 11 or of the switch 20. A rotary shaft 36 mounted in the housing 13 has a contour washer 37, in particular made in one piece therewith. The contour washer 37 extends in a plane vertical to the rotary shaft 36 and has a varying radius. The aforementioned slider projection 23 of the slider 22 or of the switch 20 extends in the same plane and flexibly presses against the outside of the contour washer 37. Due to the varying radius of the contour washer 37, the position of the slider 22 alters and thus also the position of the support 27 fastened thereto; in this connection reference is made to the prior art. The contour washer 37 has a recess 38 which in FIG. 1 is located on the left directly adjacent to the slider projection 23. This is dealt with in greater detail with reference to FIG. 2.

The switching device 11 has an electrothermic tripping device 40, as is also known from the prior art. It mainly has a heating element 41, consisting of a carrier, in particular a ceramic carrier, on whose upper side a thick-film heating conductor or other heating conductor is arranged. The heating element 41 is provided on the left with a first electrical connection 43, which discernably leads via the switch base 21 to the same connection as the switch 20.

Another, second electrical connection 44 is provided on the right of the heating element 41. A left-hand first contact spring arm 51 of a contact spring 50 is pressed against it with its free end. Since the heating element 41 has as a rule only low power, for example below 20 W or even below 10 W, no high currents need be expected, and thus contact of the contact spring 50 or of the first contact spring arm 51 is sufficient for this. Switching should also not take place at this point, as this contact should actually be permanent. It can therefore be designed relatively simple.

The contact spring 50 is bent outwards from a round metal wire and is wound in a middle area, for example three to five times, around a mounting projection 54 injection-molded on the housing lower part 14. The second contact spring arm 53 projects from the middle area downwards and is in contact with a connecting contact 55. These electrical connections 43 and 44 form the current supply to the heating element 41.

A lever 60, which has in a middle area a pivot point 61, is provided as a disconnector in FIG. 1. It is advantageously fastened to a bearing on the housing lower part 14 or rotatably mounted about the pivot point 61. A leftward-facing first lever arm 63 is in contact with the underside of the right-hand free end of the slider 22.

The rightward-facing second lever arm 65 is in contact with the lower end area of the second contact spring arm 53 or is only a very short distance to it. The lever 60 advantageously consists of plastic, for example similar plastic to the housing 13. It should in any event be electrically insulating.

For the functioning of the invention or of the disconnector in the form of the lever 60, it is firstly pointed out that the position shown in FIG. 1 is one in which the switching device 11 switches a very high power, but not yet a maximum or permanent one. In this area, a bimetal arm 46 arranged on its underside can still move downwards due to the heating up of the heating element 41 and in so doing press the right-hand free end of the switch base 21 so far downwards that it passes underneath the contact point of the tensioned arc 26 with the support 27. Then the switch 20 operates abruptly and opens the switch contact 29 and the counter-contact 31. The energy supply to the heating element 41 then stops, the bimetal arm 46 moves back again, and the right-hand free end of the switch base 21 moves upwards until the switch 20 closes again. In this state, the heating element 41 is required for the cyclic behavior of the switch 20, so it should not/may not be switched off. If however the rotary shaft 36 is turned slightly further clockwise, for example by 15°, then the slider projection 23 is precisely inside the recess 38, so that the slider 22 moves slightly further downwards. In this rotary position, which discernably only covers a very small rotary angle range or is even only a single and exact rotary position, the switching device 11 or the switch 20 should be permanently closed. Cycling of the switch 20 is therefore not wanted. Furthermore, the dimensioning may be such that the bimetal arm 46 does not, even after a lengthy period, bend so far downwards that it can open the switch 20. This should of course not happen anyway, as the switch 20 should be permanently closed.

As a result however, operation of the heating element 41 is also not necessary here, as it would on the one hand only unnecessarily consume energy; on the other hand, however, a relatively large amount of heat would be generated, as explained in the foregoing, and even with a relatively low power of the heating element 41 per se this may lead to thermal problems in the housing 13, which is usually closed except for a few vent openings. The disconnector in the form of the lever 60 is used for this. The movement of the slider 22 downwards moves the left-hand first lever arm 63 downwards too, so that the entire lever 60 rotates counter-clockwise for some distance. The second lever arm 65 is also rotated here, and comes into contact with the lower area of the second contact spring arm 53 or presses the latter away from the connecting contact 55. Hence the tripping device 40 and its heating element 41 are switched off; the heating element 41 thus does not generate heat unnecessarily, or at all, and does not unnecessarily consume energy.

The switching device 11 and the switch 20 may remain in the state shown in FIG. 2 until the rotary shaft 36 is moved/rotated again. If it is rotated counter-clockwise again for some distance, the slider 22 moves upwards and the lever 60 parts again from the lower area of the second contact spring arm 53. The latter may come back into contact with the connecting contact 55, and the heating element 41 is supplied with current again. If the rotary shaft 36 is rotated clockwise, the slider 22 is discernably moved upwards for some distance. This in turn allows the second contact spring arm 53 to rotate the lever 60 clockwise using the second lever arm 65, in order to come back into contact with the connecting contact 55.

It is thus discernable that the disconnector is only active precisely in the rotary position of FIG. 2 and interrupts the current supply to the heating element 41 and the tripping device 40. The lever 60 may be freely movable here, and must be coupled neither to the free end of the slider 22 nor to the second contact spring arm 53 in a way that it is forcibly moved. This simplifies the design of the lever 60.

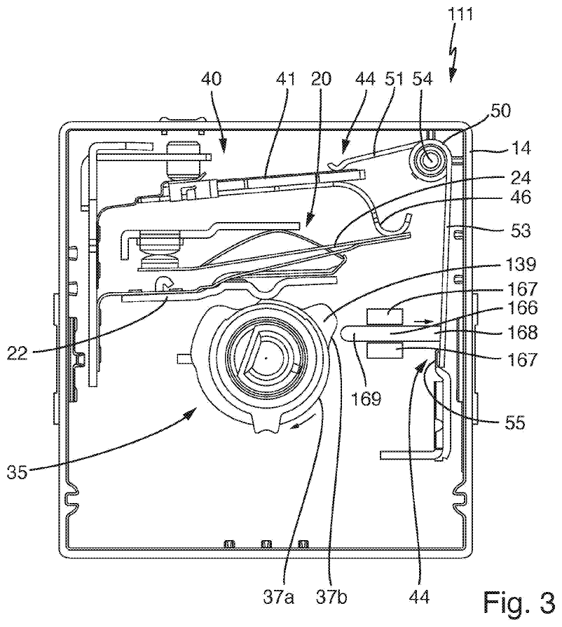

FIG. 3 shows an alternatively designed switching device 111 in which the switch 20 and the tripping device 40 are designed as in FIG. 1. Only a further contour washer 37b is provided additionally to the contour washer 37a of FIGS. 1 and 2. This further contour washer 37b may in the example shown here, be arranged underneath the contour washer 37a such that it extends underneath the slider 22 and does not move the latter. It is affected only by the contour washer 37a. The contact spring 50 too is designed exactly as in FIG. 1 with the two contact spring arms 51 and 53. The disconnector has here a pusher 166 which consists of electrically insulating plastic and is an elongated part. The pusher 166 is mounted longitudinally movable inside a linear guide 167. A right-hand end 168 is in contact with the lower area of the second contact spring arm 53 or is only a short distance from it. A left-hand end 169 extends to just in front of the facing flank of a projection 139 on the second contour washer 37b. The positions of the rotary shaft 36 and of the contour washer 37a correspond to those in FIG. 1, as does the position of the slider 22. It is easily conceivable here how, with a slightly further clockwise rotation of the rotary shaft to the right far enough for the slider projection 23 of the slider 22 to return to the recess 38 of the first contour washer 37a, the projection 139 is in contact with the left-hand end 169 of the pusher 166 and presses the latter to the right. This has the effect that the pusher 166 moves, with its right-hand end 168, the lower area of the second contact spring arm 53 to the right and thus parts from the connecting contact 55 or disconnects this connection of the tripping device 40. As a result, the heating element 41 is also permanently deactivated for as long as the rotary shaft 36 plus contour washer 37b remain in this position. In principle, the switching device 11 in FIG. 3 operates with a linear movement, and not with a rotary movement plus the lever. Furthermore, the movement of the slider 22 is not used, so that the adjusting device 35 indirectly disconnects the electrical connection to the heating element 41. Instead, the adjusting device 35 directly disconnects the electrical connection 44 or the connecting contacts 55 and 53 using the pusher 166.

The linear guide 167 for the pusher 166 may be simply molded onto the bottom 15. The pusher 166 may be inserted from the right into the linear guide and then held captively in the linear guide by pressure from the contact spring 50 or from the downwards-facing second contact spring arm 53.

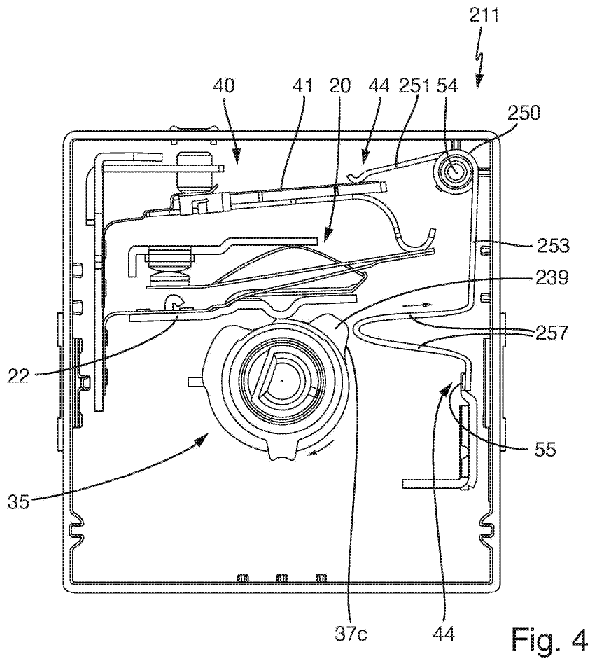

Another further embodiment of the invention is shown in FIG. 4. Here too the switch 20 and the tripping device 40 are designed as above, for which reason they are not dealt with in detail. This also applies for the first contour washer 37a. A second contour washer 37c provided here with a projection 239, similarly to in FIG. 3. However, an effectively separate disconnector in the form of the lever 60 from FIGS. 1 and 2 or of the pusher 166 according to FIG. 3 is not provided here; instead the downward-facing second contact spring arm 253 of the contact spring 250 is designed differently, or effectively emulates the pusher or integrates it into the contact spring 250. The contact spring 250 too consists of round wire as above, the second contact spring arm 253 is however provided in its lower area with a U-section 257 towards the left. The two sides of the U-section 257 could also extend with a smaller distance from one another. This U-section 257 effectively replaces the pusher 166 of FIG. 3. It extends to just in front of the projection 239, and the free end of the second contact spring arm 253 is again in contact with the connecting contact 55 as the second electrical connection 44. If the rotary shaft 36 is now in turn rotated clockwise to the right, such that the slider projection 23 of the slider 22 is inside the recess 38, the projection 239 on the second contour washer 37b moves rightwards and then downwards such that it pushes the free end of the second contact spring arm 53 away from the connecting contact 55 using the U-section 257. The second electrical connection 44 is thus opened, and the heating element 41 is, as required, no longer supplied with current.

Based on the examples shown, the basic function of the invention may be deduced per se and also in detail. Furthermore, it is discernable how the invention can be achieved with separate or with integrated disconnector, i.e. with additional components or with reshaped components. Instead of the lever 60 from FIGS. 1 and 2 or instead of the linear pusher 166 from FIG. 3, further variants are conceivable and easy to implement.

In another, further embodiment of the invention, a plastic piece might be injection-molded or fastened on the end of the U-section 257 of the specially designed contact spring 250 in FIG. 4, with which piece the second contact spring arm 253 is in electrically insulated contact with the right-hand free end of the slider 22, similarly to the lever 60 with the left-hand lever arm 63 in FIG. 1. It is discernable that the movement of the slider 22 downwards when the plastic part is suitably designed could push the lower free end of the contact spring arm 253 away from the connecting contact 55.

1. A switching device for an electrical cooking appliance, wherein said switching device has:
a housing,
a switch in said housing, said switch being designed adjustably, in its position inside said housing or in its shape, for setting different cycle times for a cyclic operation of said switch,
an adjusting device for setting different cycle times or a different cycle behavior of said switch, which acts mechanically on said switch, wherein said adjusting device has a rotary shaft with a varying contour device arranged thereon, which is arranged on said rotary shaft and has along a circumferential direction a varying contour or a varying radius,
an electrothermic tripping device for said switch, wherein said tripping device has a heating element and two electrical connections to said heating element, wherein at least one connection has two disconnectable connecting contacts in a current path of said connection,
wherein
said switching device has a disconnector which is designed to act mechanically on one of said connections of said tripping device in order to disconnect its two connecting contacts,
said disconnector is designed such that it may be moved directly or indirectly in at least one disconnecting rotary angle range of said rotary shaft by said contour device, in order to disconnect said connecting contacts in a disconnecting rotary angle range, and otherwise not.

2. The switching device according to claim 1, wherein said switching device has a metal contact spring and wherein said one connecting contact is arranged on said housing in a fixed position, wherein said other connecting contact is a contact spring arm, flexibly pressing against it, of said contact spring, and wherein another contact spring arm of said contact spring reaches said tripping device in electrically contacting manner.

3. The switching device according to claim 2, wherein said contact spring is mounted on said housing between said two ends of said contact spring arms.

4. The switching device according to claim 3, wherein said contact spring is mounted in an area of said housing between said two ends of said contact spring arms, wherein said area is arranged closer to said tripping device than to said disconnector.

5. The switching device according to claim 2, wherein said contact spring consists of a metal wire.

6. The switching device according to claim 2, wherein said contact spring has, between said contact spring arms or said ends of said contact spring arms, a holding area extending over a mounting projection on said housing such that said contact spring and said two contact spring arms are rotatable about said mounting projection.

7. The switching device according to claim 2, wherein a movable transmission member is arranged between said contour device on said rotary shaft and said connection or connecting contact, wherein said transmission member is arranged/mounted and designed such that a movement of said rotary shaft and said contour device is transmitted to said connection and to said contact spring in order to move said contact spring and thus to disconnect said connection and said connecting contacts.

8. The switching device according to claim 7, wherein said transmission member is a lever mounted for rotatable movement and having two lever ends, wherein said lever is in contact by a first lever end with said connection and with said contact spring or can be in contact depending on said rotary position.

9. The switching device according to claim 8, wherein a pivot mounting of said lever is between said two lever ends of said lever.

10. The switching device according to claim 8, wherein said other, second lever is in direct contact with said contour device such that a movement of said second lever end tripped by said rotary shaft moves and rotates said lever depending on said rotary position and disconnects said connecting contacts.

11. The switching device according to claim 8, wherein said switching device has a slider, wherein said other, second lever end is in contact with said slider, wherein said slider is in turn in contact with said contour device such that a movement of said slider tripped by said contour device depending on said rotary position is transmitted to said lever in order to rotate it and to disconnect said connecting contacts.

12. The switching device according to claim 7, wherein said transmission member is a pusher having two ends and designed movable in said linear direction.

13. The switching device according to claim 12, wherein a first end of said pusher is in contact with said contour device of said rotary shaft and said other, second end of said pusher is in contact with said connection or said connecting contact.

14. The switching device according to claim 7, wherein said transmission member consists of plastic.

15. The switching device according to claim 7, wherein said contact spring extends in a different plane vertically to said rotary shaft than said contour device or said contour washer for said disconnector.

16. The switching device according to claim 7, wherein said contact spring extends in a different plane than said transmission member.

17. The switching device according to claim 1, wherein a contact spring is provided for said one connection contact, which is shaped such that a protruding section provided thereon is in contact with said contour device of said rotary shaft.

18. The switching device according to claim 17, wherein said protruding section is bent outwards from a wire as a U-shaped section, wherein said wire forms at least one contact spring arm of said contact spring.

19. The switching device according to claim 1, wherein said rotary angle range in which said disconnector disconnects said connecting contacts is 1° to 60°.

20. The switching device according to claim 1, wherein said rotary angle range in which said disconnector disconnects said connecting contacts is arranged wherever said cycle times of said switch are such that said switch is permanently closed/switched on.

21. The switching device according to claim 1, wherein said rotary angle range is between 260° and 360°.

22. The switching device according to claim 1, wherein said contour device has at least two contour washers, which are arranged one above said other in said direction along said rotary shaft, wherein a first contour washer is provided for said switch and another, second contour washer for said disconnector.

23. A method for operating an electrical appliance with a switching device according to claim 1, wherein an electrical connection to said heating element is disconnected for permanent closing of said switch with a certain setting of said rotary shaft plus contour device in a disconnecting rotary angle range, in order to deactivate said heating element when said switch is closed.
